(19) United States
(12) Patent Application Publication
(10) Pub. No.: US 2015/0175880 A1
(43) Pub. Date: Jun. 25, 2015

(54) METHOD OF VISCOSITY REDUCTION IN THE PRESENCE OF FULLY COORDINATED COMPOUNDS

(71) Applicant: SCHLUMBERGER TECHNOLOGY CORPORATION, Sugar Land, TX (US)

(72) Inventors: Mike Parris, Richmond, TX (US); Anna Petrovna Dunaeva, Houston, TX (US); Sergey Makarychev-Mikhailov, Richmond, TX (US); Daria Sergeyevna Khvostichenko, Sugar Land, TX (US)

(21) Appl. No.: 14/561,790

(22) Filed: Dec. 5, 2014

Related U.S. Application Data
(60) Provisional application No. 61/918,809, filed on Dec. 20, 2013.

(51) Int. Cl. C09K 8/90; E21B 43/26; E21B 43/16

(52) U.S. Cl. CPC C09K 8/90; E21B 43/16; E21B 43/26

(57) ABSTRACT

Methods for reducing a viscosity of a viscosified fluid include reacting, such as by depolymerizing and/or decomposing, a polymeric material of the viscosified fluid with a breaking agent including a fully coordinated transition metal compound, such as a strongly complexed fully-coordinated transition metal compound. The methods of treating the subterranean are provided that include reacting, such as by depolymerizing and/or decomposing, a polymeric material of a viscosified treatment fluid with a fully coordinated transition metal compound, such as a strongly complexed fully-coordinated transition metal compound, to facilitate breaking of the viscosified treatment fluid after the fracturing or treatment is finished.

### CROSS-REFERENCE TO RELATED APPLICATION

This application claims the benefit of U.S. Provisional Application Ser. No. 61/918,809 filed Dec. 20, 2013 entitled “Method of viscosity reduction in the presence of fully coordinated compounds” to Parris et al. (Attorney Docket No. IS 13.4576-US-PSP), the disclosure of the provisional application is incorporated by reference herein in its entirety.

### BACKGROUND

Hydrocarbons (oil, natural gas, etc.) are obtained from a subterranean geologic formation (a “reservoir”) by drilling a well that penetrates the hydrocarbon-bearing formation. In the process of recovering hydrocarbons from subterranean formations, it is common practice to treat a hydrocarbon-bearing formation with a pressurized fluid to provide flow channels, i.e., to fracture the formation, or to use such fluids to transport and place proppant to facilitate flow of the hydrocarbons to the wellbore.

Well treatment fluids, particularly those used in fracturing (fracturing fluids), may comprise a water or oil based fluid incorporating a thickening agent, normally a polymeric material. Polymeric thickening agents for use in such fluids may comprise galactomannan gums, such as guar and substituted guars such as hydroxypropyl guar and carboxymethylhydroxypropyl guar (CMHPG). Cellulosic polymers such as carboxymethyl cellulose may also be used, as well as synthetic polymers such as polyacrylamide. Such fracturing fluids can have a high viscosity during a treatment to develop a desired fracture geometry and/or to carry proppant into a formation with sufficient resistance to settling.

The recovery of the fracturing fluid is achieved by reducing the viscosity of the fluid such that the fluid flows naturally through the proppant pack. Chemical reagents, such as oxidizers, chelants, acids and enzymes may be employed to break the polymer networks to reduce their viscosity. These materials are commonly referred to as “breakers” or “breaking agents.” Such conventional fracturing fluid breaking technologies are known and are suitable in some environments.

### BRIEF DESCRIPTION OF DRAWINGS

FIG. 1 shows a graphical representation describing various chelated iron (III) complexes.

FIG. 2 shows a graphical representation of a rheology profile according to one of the embodiments described herein.

FIG. 3 shows a graphical representation of a rheology profile according to one of the embodiments described herein.

FIG. 4 shows a graphical representation of a rheology profile according to one of the embodiments described herein.

FIG. 5 shows a graphical representation of a rheology profile according to one of the embodiments described herein.

FIG. 6 shows a graphical representation of a rheology profile according to one of the embodiments described herein.

FIG. 7 shows a graphical representation of a rheology profile according to one of the embodiments described herein.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In some embodiments, the present disclosure relates to methods for reducing the viscosity of a viscosified fluid. Such methods may include introducing a viscosified fluid into a subterranean formation, and reducing the viscosity of the viscosified fluid by reacting a polymeric material (such as by depolymerizing and/or decomposing the polymeric material) of the viscosified fluid with a breaking agent including a fully coordinated transition metal compound, such as a strongly complexed fully-coordinated transition metal compound.

The present disclosure also relates to methods of treating a subterranean formation penetrated by a wellbore, which include forming a viscosified treatment fluid, treating the subterranean formation with the viscosified treatment fluid to fracture the subterranean formation. After the subterranean formation has been fractured, the viscosity of the viscosified treatment fluid is reduced by at least 80% by introducing a breaking agent to the viscosified treatment fluid. The breaking agent including a fully coordinated transition metal compound, such as a strongly complexed fully-coordinated transition metal compound.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation-specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, (1) even if numerous specific data points within the range are explicitly identified, (2) even if reference is made to a few specific data points within the range, or (3) even when no data points within the range are explicitly identified, it is to be understood (i) that the inventors appreciate and understand that any conceivable data point within the range is to be considered to have been specified, and (ii) that the inventors possessed knowledge of the entire range, each conceivable sub-range within the range, and each conceivable point within the range.

The present disclosure is generally directed toward breaking fracturing fluids or viscosified fluids in a controlled fashion using a breaking agent (also referred to as a “breaker”) comprising at least one fully-coordinated transition metal compound, such as at least one fully-coordinated iron compound, such as a hexacyanoferrate salt (for example, potassium hexacyanoferrate(III) and/or potassium hexacyanoferrate(II)). Such hexacyanoferrate salts include those of alkali and alkaline earth metals, ammonium hexacyanoferrate salts and their hydrates.

The phrase “fully-coordinated” as used in the expression “fully-coordinated transition metal compound” refers to transition metal compounds having a number of ligands, such as a number of ligands that corresponds to the maximum coordination number for a the transition metal (which is related to the electronic configuration of the transition metal ion). The phrase “strongly complexed” refers to a “fully-coordinated transition metal compound” “strongly that has a formation constant (log K) above about 28 under ambient conditions, such as a log formation constant in the range of from about 28 to about 80 under ambient conditions, or in the range of from about 30 to about 75 under ambient conditions, or in the range of from about 45 to about 70 under ambient conditions. In some embodiments, the fully-coordinated transition metal compounds, such as strongly complexed fully-coordinated transition metal compounds, may be compounds known as siderophores, which may be biologically-produced.

Formation constants for related complexed compounds may vary, for example, depending on the oxidation state of the transition metal, the ligand number and/or coordination number, among other factors. For example, the following table illustrates some of the variation in that some complexes may have a formation constant above about 28 under ambient conditions for only some oxidation states of the transition metal but not others, while some combinations of transition metals and ligands may not have a formation constant above about 28 under ambient conditions. In the following table, the fully-coordinated transition metal compounds are identified in terms of their log K (formation constant), which is in the left column of the table. Such formation constants in the table are known and may be found in the literature, such as, for example, for the cyanides the formation constants were taken from: Ullman's Encyclopedia of Industrial Chemistry, Wiley-VCH Verlag GmbH&Co, 2004., and for the other compounds: NIST Critical Stability Constant Database No. 46.

TABLE 1
Formation constants of fully-coordinated transition metal compounds, including some strongly complexed
fully-coordinated transition metal compounds (having a formation constant (Log K) above about 28).

| Name | Chemical Formulae |
|---|---|
| Fe/HBED: Iron(III) and iron(II) complexes of sodium salt N,N′-di(2- hydroxybenzyl)ethylenediamine-N,N′- diacetic acid Log K = 39.0 (Fe⁺³ complex) Log K = 22.7 (Fe⁺² complex)* | 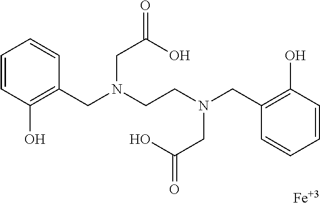 |
| Fe/DTPA: Diethylene triamine pentacetic acid complexes with Iron(III) and (II) Log K = 28.0 (Fe⁺³ complex) Log K = 16.4 (Fe⁺² complex)* | 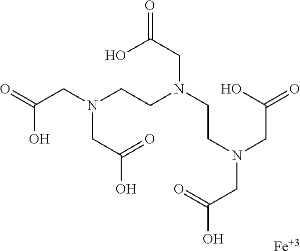 |
| Fe/EDTA: ferric ethylenediamintetraacetic acid Log K = 25.1 (Fe⁺³ complex) Log K = 14.3 (Fe⁺² complex)* | 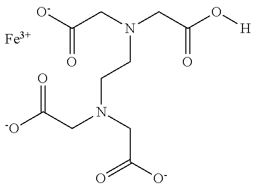 |
| Hexacyanoferrate(II) [Fe(CN)₆]⁻⁴ (ferrocyanide) Log K = 36** | 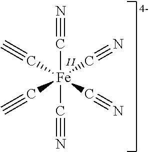 |
| Hexacyanoferrate(III) [Fe(CN)₆]⁻³ (ferricyanide) Log K = 42** | 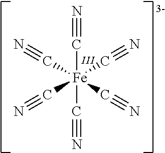 |
| Hexacyanocobaltate(III) Log K = 64** | 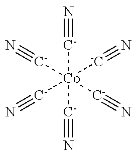 |
| Iron citrate Log K = 3.2 (Fe⁺² complex) Log K = 11.8 (Fe⁺³ complex)* | C₆H₁₀FeO₆C₆H₆FeO₇ |
| Ferrichrome siderophore Log K = 29 *** | 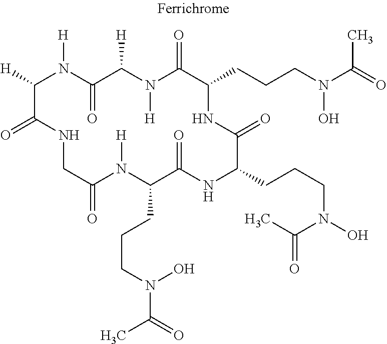 |

*NIST Critical Stability Constant Database No. 46
**Ullmann's Encyclopedia of Industrial Chemistry, 2004, Wiley Interscience
*** Biochemistry: The Chemical Reaction of Living Cells, 2001, Academic Press

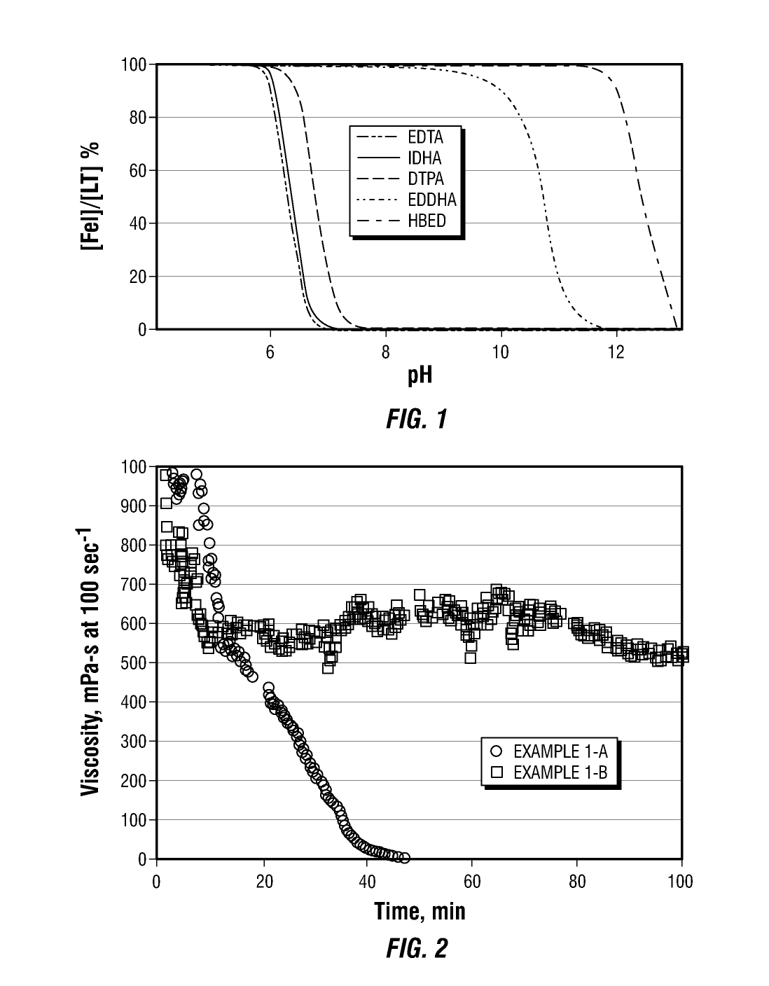

Some complexes may not possess a formation constant above about 28 (such as the iron EDTA complex) due to, for example, instability at high pH. As shown in FIG. 1, taken from Van Iperen, International [http://www.vaniperen.com/Solutions/Fertilizer-solutions.aspx], indicates that the HBED/Fe(III) remains complexed at high pHs, whereas those complexes with lower formation constants, such as EDTA/Fe(III), do not. This aspect may be desirable for various treatment fluids, for example, alkaline fracturing fluids, such as polymeric fluids crosslinked with boron.

The transition metal in the at least one fully-coordinated transition metal compound, such as at least one strongly complexed fully-coordinated transition metal compound, may be any appropriate transition metal that is capable of forming a fully-coordinated transition metal compound, such as strongly complexed fully-coordinated transition metal compound (with one or more ligands, such as those discussed below, including, for example, ammonia, water, carbon monoxide, pyridine, azide, bromide, chloride, cyanide, fluoride, hydroxide, nitrite, thiocyanate, bipyridine, ethylenediamine, carbonate, oxide, oxalate, and sulfate) that possesses a structure having a log formation constant above about 28, such as a log formation constant in the range of from about 28 to about 80, or in the range of from about 30 to about 75, or in the range of from about 45 to about 70. For example, the metal may be selected from one of the known transition metal containing groups of the periodic table, including metals such as, for example, Sc, Y, Ti, Zr, Hf, V, Nb, Ta, Cr, Mo, W, Mn, Re, Fe, Ro, Os, Co, Rh, Ir, Ni, Pd, Pt, Cu, Ag, Au, Zn, Cd, and Hg. Ionic states (oxidation states) of the above metals may include, for example, Sc³⁺, Y³⁺, Ti⁴⁺, Zr⁴⁺, HF⁴⁺, V⁴⁺, V³⁺, V²⁺, Nb³⁺, Ta³⁺, Cr³⁺, Mo³⁺, W³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, and Hg²⁺.

The ligand(s) in the at least one fully-coordinated transition metal compound, such as at least one strongly complexed fully-coordinated transition metal compound, may be any appropriate ligand that is capable of forming a fully-coordinated transition metal compound, such as strongly complexed fully-coordinated transition metal compound (with at least one of the above-mentioned transition metals, which may be present in one of the above oxidation states) that possesses a structure having a log formation constant above about 28, such as a log formation constant in the range of from about 28 to about 80, or in the range of from about 30 to about 75, or in the range of from about 45 to about 70. Suitable ligands may include carbon monoxide, nitrogen monoxide, cyanides, alkylcyanides, such as, for example, acetonitrile, arylcyanides, benzonitrile, alkylisocyanides, methylisonitrile, arylisocyanides, benzoisonitrile, amines, trimethylamine, triethylamine, morpholine, phosphines, halophosphines, trialkylphosphines, triarylphosphines, alkylarylphosphines, trifluorophosphine, trimethylphosphine, tricyclohexylphosphine, tri-tert-butylphosphine, triphenylphosphine, tris(pentafluorophenyl)phosphine, phosphites, trimethyl phosphite, triethyl phosphite, arsines, trifluoroarsine, trimethylarsine, tricyclohexylarsine, tri-tert-butylarsine, triphenylarsine, tris(pentafluorophenyl)arsine, stibines, trifluorostibine, trimethylstibine, tricyclohexyl-stibine, tri-tert-butylstibine, triphenylstibine, tris(pentafluorophenyl)stibine, nitrogen-containing heterocycles, pyridine, pyridazine, pyrazine, pyrimidine, triazine, carbenes, arduengo carbenes, hydride, deuteride, halides, F, Cl⁻, Br⁻ and I⁻, alkylacetylides, arylacetylides, cyanide, cyanate, isocyanate, thiocyanate, isothiocyanate, aliphatic, aromatic alcoholates, methanolate, ethanolate, propanolate, isopropanolate, tert-butylate, phenolate, aliphatic or aromatic thioalcoholates, methanethiolate, ethanethiolate, propanethiolate, isopropanethiolate, tert-thiobutylate, thiophenolate, amides, dimethylamide, diethylamide, diisopropylamide, morpholide, carboxylates, acetate, trifluoroacetate, propionate, benzoate, aryl groups, phenyl, naphthyl, anionic nitrogen-containing heterocycles, pyrrolide, imidazolide, pyrazolide, O²⁻, S²⁻, carbides, nitrenes, diamines, ethylenediamine, N,N,N′,N′-tetramethylethylenediamine, propylenediamine, N,N,N′,N′-tetramethylpropylenediamine, cis- or trans-diaminocyclohexane, cis- or trans-N,N,N′,N′-tetramethyldiaminocyclohexane, imines, 2-[1-(phenylimino)ethyl]pyridine, 2[1-(2-methylphenylimino)ethyl]pyridine, 2[1-(2,6-di-iso-propylphenylimino)ethyl]pyridine, 2-[1-(methylimino)ethyl]-pyridine, 2-[1-(ethylimino)ethyl]pyridine, 2[1-(iso-propylimino)ethyl]pyridine, 2[1-(tert-butylimino)ethyl]pyridine, diimines, 1,2-bis(methylimino)ethane, 1,2-bis(ethylimino)ethane, 1,2-bis(iso-propylimino)ethane, 1,2-bis(tert-butylimino)ethane, 2,3-bis(methylimino)butane, 2,3-bis(ethylimino)butane, 2,3-bis(iso-propylimino)butane, 2,3-bis(tert-butylimino)butane, 1,2-bis(phenylimino)ethane, 1,2-bis(2-methylphenylimino)ethane, 1,2-bis(2,6-di-iso-propylphenylimino)ethane, 1,2-bis(2,6-di-tert-butylphenylimino)ethane, 2,3-bis(phenylimino)butane, 2,3-bis(2-methylphenylimino)butane, 2,3-bis(2,6-di-iso-propylphenylimino)butane, 2,3-bis(2,6-di-tertbutylphenylimino)butane, heterocycles containing two nitrogen atoms, 2,2′-bipyridine, o-phenanthroline, diphosphines, bis(diphenylphosphino)methane, bis(diphenylphosphino)ethane, bis(diphenylphosphino)propane, bis(diphenylphosphino)butane, bis(dimethylphosphino)methane, bis(dimethylphosphino)ethane, bis(dimethylphosphino)propane, bis(diethylphosphino)methane, bis(diethylphosphino)ethane, bis(diethylphosphino)propane, bis(di-tert-butylphosphino)methane, bis(di-tert-butylphosphino)ethane, bis(tert-butylphosphino)propane, 1,3-diketonates derived from 1,3-diketones, acetylacetone, benzoylacetone, 1,5-diphenylacetylacetone, dibenzoylmethane, bis(1,1,1-trifluoroacetyl)methane, 3-ketonates derived from 3-ketoesters, ethyl acetoacetate, carboxylates derived from aminocarboxylic acids, pyridine-2-carboxylic acid, quinoline-2-carboxylic acid, glycine, N,N-dimethylglycine, alanine, N,N-dimethylaminoalanine, salicyliminates derived from salicylimines, methylsalicylimine, ethylsalicylimine, phenylsalicylimine, dialcoholates derived from dialcohols, ethylene glycol, 1,3-propylene glycol, dithiolates derived from dithiols, 1,2-ethylenedithiol, 1,3-propylenedithiol, oxalic acid, succinic acid, tartaric acid, 1,4-butanedicarboxylic acid, 4-oxopyran-2,6-dicarboxylic acid, 1,6-hexanedicarboxylic acid, decanedicarboxylic acid, 1,8-heptadecanedicarboxylic acid, 1,9-heptadecanedicarboxylic acid, heptadecanedicarboxylic acid, acetylenedicarboxylic acid, 1,2-benzenedicarboxylic acid, 2,3-pyridinedicarboxylic acid, pyridine-2,3-dicarboxylic acid, 1,3-butadiene-1,4-dicarboxylic acid, 1,4-benzenedicarboxylic acid, p-benzenedicarboxylic acid, imidazole-2,4-dicarboxylic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenyl ethane-3,3′-dicarboxylic acid, quinoline-3,4-dicarboxylic acid, 7-chloro-4-hydroxyquinoline-2,8-dicarboxylic acid, diimidodicarboxylic acid, pyridine-2,6-dicarboxylic acid, 2-methylimidazole-4,5-dicarboxylic acid, thiophene-3,4-dicarboxylic acid, 2-isopropylimidazole-4,5-dicarboxylic acid, tetrahydropyran-4,4-dicarboxylic acid, perylene-3,9-dicarboxylic acid, perylenedicarboxylic acid, 3,6-dioxaoctanedicarboxylic acid, 3,5-cyclohexadiene-1,2-dicarboxylic acid, octadicarboxylic acid, pentane-3,3-carboxylic acid, 4,4′-diamino-1,1′-diphenyl-3,3′-dicarboxylic acid, 4,4′-diaminodiphenyl-3,3′-dicarboxylic acid, benzidene-3,3′-dicarboxylic acid, 1,4-bis(phenylamino)benzene-2,5-dicarboxylic acid, 1,1′-dinaphthyl-5,5′-dicarboxylic acid, 7-chloro-8-methylquinoline-2,3-dicarboxylic acid, 1-anilinoanthraquinone-2,4′-dicarboxylic acid, polytetrahydrofuran-250-dicarboxylic acid, 1,4-bis(carboxymethyl)piperazine-2,3-dicarboxylic acid, 7-chloroquinoline-3,8-dicarboxylic acid, 1-(4-carboxyl)phenyl-3-(4-chloro)phenylpyrazoline-4,5-dicarboxylic acid, 1,4,5,6,7,7-hexachloro-5-norbornene-2,3-dicarboxylic acid, phenylindanedicarboxylic acid, 1,3-dibenzyl-2-oxoimidazoline-4,5-dicarboxylic acid, 1,4-cyclohexanedicarboxylic acid, naphthalene-1,8-dicarboxylic acid, 2-benzoylbenzene-1,3-dicarboxylic acid, 1,3-dibenzyl-2-oxoimidazolidine-4,5-cis-dicarboxylic acid, 2,2′-biquinoline-4,4′-dicarboxylic acid, pyridine-3,4-dicarboxylic acid, 3,6,9-trioxaundecanedicarboxylic acid, O-hydroxybenzophenonedicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazinedicarboxylic acid, 4,4′-diaminodiphenyl ether diimidodicarboxylic acid, 4,4′-diaminodiphenylmethanediimidodicarboxylic acid, 4,4′-diaminodiphenyl sulfone diimidodicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenecarboxylic acid, 8-sulfo-2,3-naphthalenedicarboxylic acid, anthracene-2,3-dicarboxylic acid, 2′,3′-diphenyl-p-terphenyl-4,4″-dicarboxylic acid, diphenyl ether 4,4′-dicarboxylic acid, imidazole-4,5-dicarboxylic acid, 4(1H)-oxothiochromene-2,8-dicarboxylic acid, 5-tert-butyl-1,3-benzenedicarboxylic acid, 7,8-quinolinedicarboxylic acid, 4,5-imidazoledicarboxylic acid, 4-cyclohexene-1,2-dicarboxylic acid, hexatricontanedicarboxylic acid, tetradecanedicarboxylic acid, 1,7-heptadicarboxylic acid, 5-hydroxy-1,3-benzenedicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxydiphenylmethane-3,3′-dicarboxylic acid, 1-amino-4-methyl-9,10-dioxo-9,10-dihydroanthracene-2,3-dicarboxylic acid, 2,5-pyridinedicarboxylic acid, cyclohexene-2,3-dicarboxylic acid, 2,9-dichlorofluoroubin-4,11-dicarboxylic acid, 7-chloro-3-mnethylquinoline-6,8-dicarboxylic acid, 2,4-dichlorobenzophenone-2′,5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitrobenzene-1,4-dicarboxylic acid, heptane-1,7-dicarboxylic acid, cyclobutane-1,1-dicarboxylic acid, 1,14-tetradecanedicarboxylic acid, 5,6-dehydronorbornane-2,3-dicarboxylic acid, 5-ethyl-2,3-pyridinedicarboxylic acid, 2-hydroxy-1,2,3-propanetricarboxylic acid, 7-chloro-2,3,8-quinolinetricarboxylic acid, 1,2,4-benzenetricarboxylic acid, 1,2,4-butanetricarboxylic acid, 2-phosphon-1,2,4-butanetricarboxylic acid, 1,3,5-benzenetricarboxylic acid, 1-hydroxy-1,2,3-propanetricarboxylic acid, 4,5-dihydro-4,5-dioxo-1H-pyrrolo[2,3-F]quinoline-2,7,9-tricarboxylic acid, 5-acetyl-3-amino-6-methylbenzene-1,2,4-tricarboxylic acid, 3-amino-5-benzoyl-6-methylbenzene-1,2,4-tricarboxylic acid, 1,2,3-propanetricarboxylic acid, aurinetricarboxylic acid, 1,1-dioxoperylo[1,12-BCD]thiophene-3,4,9,10-tetracarboxylic acid, perylene-tetracarboxylic acids, such as perylene-3,4,9,10-tetracarboxylic acid or perylene-1,12-sulfonyl-3,4,9,10-tetracarboxylic acid, butanetetracarboxylic acids, such as 1,2,3,4-butanetetracarboxylic acid or meso-1,2,3,4-butanetetracarboxylic acid, decane-2,4,6,8-tetracarboxylic acid, 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octanetetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofurantetracarboxylic acid or cyclopentanetetracarboxylic acids, and cyclopentane-1,2,3,4-tetracarboxylic acid. In some embodiments, combinations of one or more monodentate ligands, one or more bidentate ligands and one or more multidentate ligands may be used.

In embodiments, breaking the viscosified fluids with a breaking agent comprising at least one fully-coordinated transition metal compound, such as at least one strongly complexed fully-coordinated transition metal compound, or at least one fully coordinated iron compound, such as a hexacyanoferrate salt (for example, potassium hexacyanoferrate(III) and/or potassium hexacyanoferrate(II)), occurs at any desired temperature, such as temperature in a range of from about 60° C. to about 135° C., such as from about 80° C. to about 250° C., or from about 100° C. to about 200° C.

The methods of the present disclosure may also include treating a subterranean formation penetrated by a wellbore. Such methods may comprise contacting and/or reacting a viscosified treatment fluid, such as a viscosified polymer treatment fluid introduced into the formation via the wellbore, with a breaking agent comprising at least one fully-coordinated transition metal compound, such as at least one strongly complexed fully-coordinated transition metal compound, or at least one fully-coordinated iron compound, such as a hexacyanoferrate salt (for example, potassium hexacyanoferrate(III) and/or potassium hexacyanoferrate(II)). In embodiments, the methods of the present disclosure facilitate breaking of the viscosified treatment fluid after the fracturing or treatment is finished.

In embodiments, the “reaction” of the viscosified fluid (“viscosified treatment fluid” or “viscosified fluid for treatment”) with the breaking agents or breakers to reduce the viscosity of the viscosified fluid (the breaking effect) may occur under any desired conditions, such a set of conditions experienced in a subterranean formation (for example, in a downhole environment). For example, in some embodiments, the reaction of the viscosified fluid with the breaking agent comprising at least one fully-coordinated transition metal compound, such as at least one strongly complexed fully-coordinated transition metal compound, or at least one fully coordinated iron compound, such as a hexacyanoferrate salt (for example, potassium hexacyanoferrate(III) and/or potassium hexacyanoferrate(II)) may occur (that is, the breaking effect of the breaking agent may be accomplished) in the presence of ions (such as, for example, Ca²⁺ and Mg²⁺) found in many mix-waters used to create fracturing fluids. Such ions (for example, Ca²⁺ and/or Mg²⁺) may be present in the treatment fluid in an amount above about 5 ppm by weight of the treatment fluid, such as in an amount from about 10 ppm to about 10,000 by weight of the treatment fluid, in an amount from about 100 ppm to about 5,000 ppm by weight of the treatment fluid, or in an amount from about 500 ppm to about 2,000 by weight of the treatment fluid. In such embodiments, the breaking effect of the breaking agent comprising at least one fully-coordinated transition metal compound, such as at least one strongly complexed fully-coordinated transition metal compound, or at least one fully coordinated iron compound, such as a hexacyanoferrate salt (for example, potassium hexacyanoferrate(III) and/or potassium hexacyanoferrate(II)), may be accomplished either in the presence or absence of an additional breaker or breaking aid.

In some embodiments, the breaking effect of the breaking agent comprising at least one fully-coordinated transition metal compound, such as at least one strongly complexed fully-coordinated transition metal compound, or at least one fully coordinated iron compound, such as a hexacyanoferrate salt (for example, potassium hexacyanoferrate(III) and/or potassium hexacyanoferrate(II)), may be accomplished in the presence of oxygen. For example, oxygen (such as dissolved oxygen (O₂)) may be present in the treatment fluid in an amount above about 3 ppm, such as in an amount from about 3 ppm to about 17 ppm, or in an amount from about 5 ppm to about 15 ppm, or in an amount from about 8 ppm to about 12 ppm.

In some embodiments, the “reaction” of the viscosified fluid with the breaking agents or breakers to reduce the viscosity of the viscosified fluid (the breaking effect) does not substantially occur, or does not occur, until the breaking agent is exposed to the predetermined subterranean conditions. In some embodiments, such a reaction, which may include the breaking agent (at least one fully-coordinated transition metal compound, such as at least one strongly complexed fully-coordinated transition metal compound, or at least one fully coordinated iron compound, such as a hexacyanoferrate salt (for example, potassium hexacyanoferrate(III) and/or potassium hexacyanoferrate(II)) reacting with the polymeric material of the viscosified fluid to decompose and/or depolymerize the polymeric material of the viscosified fluid, does not substantially occur, or does not occur, until the breaking agent is down hole and exposed one or more conditions sufficient to initiate the breaking effect of the breaking agent.

The design of fracturing treatments is described in U.S. Pat. No. 7,337,839, which is incorporated herein by reference in its entirety. Although the present disclosure describes the use of a breaking agent comprising at least one fully-coordinated transition metal compound, such as at least one strongly complexed fully-coordinated transition metal compound, or at least one fully coordinated iron compound, such as a hexacyanoferrate salt (for example, potassium hexacyanoferrate(III) and/or potassium hexacyanoferrate(II)), in fracturing treatments, it can also be used in other treatments.

In some embodiments, the breaking agent or breaker comprising at least one fully-coordinated transition metal compound, such as at least one strongly complexed fully-coordinated transition metal compound, or at least one fully-coordinated iron compound, such as a hexacyanoferrate salt (for example, potassium hexacyanoferrate(III) and/or potassium hexacyanoferrate(II)) may be in a solid form. When in a solid form, the at least one fully-coordinated transition metal compound, such as at least one strongly complexed fully-coordinated transition metal compound, or at least one fully-coordinated iron compound, such as a hexacyanoferrate salt (for example, potassium hexacyanoferrate(III) and/or potassium hexacyanoferrate(II)), may be a crystalline or granular material. The solid form may be encapsulated or provided with a coating to delay its release into the treatment fluid. Encapsulating materials and methods of encapsulating breaking materials are known in the art. Such materials and methods may be used for the breaker comprising at least one fully-coordinated transition metal compound, such as at least one strongly complexed fully-coordinated transition metal compound, or at least one fully-coordinated iron compound, such as a hexacyanoferrate salt (for example, potassium hexacyanoferrate(III) and/or potassium hexacyanoferrate(II)), of the present disclosure. Examples of materials and methods that may be used for encapsulation are described, for example, in U.S. Pat. Nos. 4,741,401; 4,919,209; 6,162,766 and 6,357,527, the disclosures of which are incorporated herein by reference in their entireties.

When used as a liquid or fluid, the breaking agent comprising at least one fully-coordinated transition metal compound, such as at least one strongly complexed fully-coordinated transition metal compound, or at least one fully coordinated iron compound, such as a hexacyanoferrate salt (for example, potassium hexacyanoferrate(III) and/or potassium hexacyanoferrate(II)), may be dissolved in any suitable solvent, such as, for example, an aqueous solution. The breaking agent comprising at least one fully-coordinated transition metal compound, such as at least one strongly complexed fully-coordinated transition metal compound, or at least one fully-coordinated iron compound, such as hexacyanoferrate salt (for example, potassium hexacyanoferrate(III) and/or potassium hexacyanoferrate(II)), may be soluble in water, that is, the breaking agents may have a solubility of greater than 1 g (or more) in 100 g of water at room temperature, as measured using iodometric titration methods. In some embodiments, the breaking agent comprising at least one fully-coordinated transition metal compound, such as at least one strongly complexed fully-coordinated transition metal compound, or at least one fully coordinated iron compound, such as a hexacyanoferrate salt (for example, potassium hexacyanoferrate(III) and/or potassium hexacyanoferrate(II)), of the present disclosure may have solubilities of 5 g or more in 100 g of water, such as 10 g or more in 100 g of water.

The breaker (or breaking agent) comprising at least one fully-coordinated transition metal compound, such as at least one strongly complexed fully-coordinated transition metal compound, or at least one fully coordinated iron compound, such as a hexacyanoferrate salt (for example, potassium hexacyanoferrate(III) and/or potassium hexacyanoferrate(II)), may be added to the viscosified or unviscosified treatment fluid before this fluid is introduced into the well bore, or the breaker or breaking agent may be added as a separate fluid, such as an aqueous or organic based fluid, that is introduced into the wellbore after at least a portion or the entire amount of viscosified or unviscosified treatment fluid has been introduced into the wellbore.

The amount of the breaker comprising at least one fully-coordinated transition metal compound, such as at least one strongly complexed fully-coordinated transition metal compound, or at least one fully coordinated iron compound, such as a hexacyanoferrate salt (for example, potassium hexacyanoferrate(III) and/or potassium hexacyanoferrate(II)), present in the viscosified or unviscosified treatment fluid (or aqueous or organic based fluid) may depend on several factors including the specific breaker selected, the amount and ratio of the other components in the viscosified or unviscosified treatment fluid (or aqueous or organic based fluid), the contacting time desired, the temperature, pH, and ionic strength of the viscosified or unviscosified treatment fluid (or aqueous or organic based fluid).

In embodiments where in the breaking agent is introduced in a fluid separate from the viscosified or unviscosified fluid, the breaking agent may be incorporated into an aqueous or organic based fluid in which the breaking agent comprising at least one fully-coordinated transition metal compound, such as at least one strongly complexed fully-coordinated transition metal compound, or at least one fully coordinated iron compound, such as a hexacyanoferrate salt (for example, potassium hexacyanoferrate(III) and/or potassium hexacyanoferrate(II)), may present in an amount above about 0.0005% by weight of the aqueous or organic based fluid, such as in an amount from about 0.002% to about 0.1% by weight of aqueous or organic based fluid, in an amount from about 0.003% to about 0.01% by weight of the aqueous or organic based fluid, or in an amount from about 0.004% to about 0.008% by weight of the aqueous or organic based fluid.

The breaking agent comprising at least one fully-coordinated transition metal compound, such as at least one strongly complexed fully-coordinated transition metal compound, or at least one fully-coordinated iron compound, such as a hexacyanoferrate salt (for example, potassium hexacyanoferrate(III) and/or potassium hexacyanoferrate(II)), may be present in the viscosified or unviscosified fluid (added before introducing the viscosified or unviscosified treatment fluid into the wellbore) in an amount above about 0.0005% by weight of the viscosified or unviscosified fluid, such as in an amount from about 0.01% to about 0.6% by weight of the viscosified or unviscosified fluid, in an amount from about 0.04% to about 0.3% by weight of the viscosified or unviscosified fluid, or in an amount from about 0.05% to about 0.01% by weight of the viscosified or unviscosified fluid. In such embodiments, the concentration ratio of the breaking agent to the polymeric material (breaking agent:polymeric material) in the viscosified or unviscosified fluids may be in a range of from about 1:100 to about 1:4, such as a concentration ratio in range of from about 1:50 to about 1:5, a concentration ratio in range of from about 1:40 to about 1:6, or a concentration ratio in range of from about 1:30 to about 1:7.

As used herein, the phrases “viscosified fluid,” “viscosified treatment fluid” or “viscosified fluid for treatment” (hereinafter generally referred to as a “viscosified fluid” unless specified otherwise) mean, for example, a composition comprising a solvent, a viscosifying material, such as a polymeric material, which may include any crosslinkable compound and/or substance with a crosslinkable moiety (hereinafter “crosslinkable component”), and optionally at least one fully-coordinated transition metal compound, such as at least one strongly complexed fully-coordinated transition metal compound, or at least one fully-coordinated iron compound, such as a hexacyanoferrate salt (for example, potassium hexacyanoferrate(III) and/or potassium hexacyanoferrate(II)). The viscosified fluids of the present disclosure may be substantially inert to any produced fluids (gases and liquids) and other fluids injected into the wellbore or around the wellbore.

The breaking agents or breakers of the present disclosure may be activated to initiate the “reaction” of the viscosified treatment fluid with the breaking agents or breakers to reduce the molecular weight of the polymeric materials (the breaking effect). In embodiments, the breaking action of the breaking agents or breakers of the present disclosure may be initiated by subterranean environmental conditions, such as temperature or pH, of the subterranean zone in which they are placed. In embodiments when breaker or breaking agent is added to the viscosified or unviscosified treatment fluid either before or after the fluid is introduced into the well bore, the “reaction” of the viscosified treatment fluid with the breaking agents or breakers (the breaking effect) does not substantially occur until the breaking agent is exposed to a downhole or subterranean condition. In other words, the reduction of the viscosity, such as the viscosity reduction as a result of the breaking agent reacting with the polymeric material of the viscosified fluid to decompose and/or depolymerize the polymeric material, of the viscosified fluid does not substantially occur until the breaking agent is down hole and exposed to a downhole or subterranean condition sufficient initiate the breaking effect of the breaking agent.

In some embodiments, the reduction of the viscosity, such as the viscosity reduction as a result of the breaking agent acting to decompose and/or depolymerize the polymeric material, of the viscosified fluid does not occur to any extent until the breaking agent is exposed to a downhole or subterranean condition sufficient initiate the breaking effect of the breaking agent.

In embodiments, the above breaking effect of the breaking agent comprising at least one fully-coordinated transition metal compound, such as at least one strongly complexed fully-coordinated transition metal compound, or at least one fully-coordinated iron compound, such as a hexacyanoferrate salt (for example, potassium hexacyanoferrate(III) and/or potassium hexacyanoferrate(II)), may begin in at a time from about 5 minutes to about 600 minutes after being exposed to a downhole or subterranean condition sufficient initiate the breaking effect of the breaking agent, such as a time from about 30 minutes to about 300 minutes, a time from about 45 minutes to about 150 minutes, or a time from about 60 minutes to about 90 minutes after being exposed to the downhole or subterranean condition sufficient initiate the breaking effect of the breaking agent, which optionally may be encapsulated to delay the breaking effect.

In embodiments, the breaking effect of the breaking agent comprising at least one fully-coordinated transition metal compound, such as at least one strongly complexed fully-coordinated transition metal compound, or at least one fully-coordinated iron compound, such as a hexacyanoferrate salt (for example, potassium hexacyanoferrate(III) and/or potassium hexacyanoferrate(II)), may be accomplished either in the presence or absence of an additional breaker or breaking aid. Such a breaking aid may be a breaker activator that is present to activate the breaking agent. Breaking aids may include ureas, ammonium chloride and the like, and those disclosed in, for example, U.S. Pat. Nos. 4,969,526, and 4,250,044, the disclosures of which are incorporated herein by reference in their entireties.

In embodiments where a breaking aid is present, the amount of breaking aid and/or breaker activator that may be included in the viscosified or unviscosified treatment fluid (or aqueous or organic based fluid) is an amount that will sufficiently activate the breaking effect of the breaking agent. Factors including the injection time desired, the polymeric material and its concentration, and the formation temperature. In embodiments, the additional breaking aid and/or breaker activator may be present in the viscosified or unviscosified treatment fluid (or aqueous or organic based fluid) in an amount in the range of from about 0.01% to about 1.0% by weight, such as from about 0.05% to about 0.5% by weight, of the viscosified or unviscosified treatment fluid (or aqueous or organic based fluid).

In some embodiments, the breaking effect of the breaking agent comprising at least one fully-coordinated transition metal compound, such as at least one strongly complexed fully-coordinated transition metal compound, or at least one fully-coordinated iron compound, such as a hexacyanoferrate(II) salt (for example, potassium hexacyanoferrate(II), also known as potassium ferrocyanide) and/or a hexacyanoferrate(III) salt (for example, potassium hexacyanoferrate(III), also known as potassium ferricyanide), may be accomplished in the absence of any additional component that may be characterized as possessing a breaker function and/or a breaking aid function. For example, in some embodiments, no additional breaker (or breaking agent), breaking aid and/or breaker activator may be present to assist in accomplishing the breaking effect of the breaking agent comprising at least one fully-coordinated transition metal compound, such as at least one strongly complexed fully-coordinated transition metal compound, or at least one fully coordinated iron compound, such as a hexacyanoferrate salt (for example, potassium hexacyanoferrate(III) and/or potassium hexacyanoferrate(II)).

The polymers present in the viscosified fluid may be those commonly used with fracturing fluids. The polymers may be used in either crosslinked or non-crosslinked form. The polymers may be capable of being crosslinked with any suitable crosslinking agent, such as metal ion crosslinking agents. Examples of such materials include the polyvalent metal ions of boron, aluminum, antimony, zirconium, titanium, chromium, etc., that react with the polymers to form a composition with adequate and targeted viscosity properties for various operations. The crosslinking agent may be added in an amount that results in suitable viscosity and stability of the gel at the temperature of use. Crosslinkers may be added at concentrations of about 5 to about 500 parts per million (ppm) of active atomic weight. That concentration may be adjusted based on the polymer concentration.

The crosslinker may be added as a solution and may include a ligand which delays the crosslinking reaction. This delay may be beneficial in that the high viscosity fracturing fluid is not formed until near the bottom of the wellbore to minimize frictional pressure losses and may prevent irreversible shear degradation of the gel, such as when Zr or Ti crosslinking agents are used. Delayed crosslinking may be time, temperature or both time and temperature controlled to facilitate a successful fracturing process.

Other crosslinkers may include organic crosslinkers such as polyethyleneimines, aldehydes, phenol-aldehydes, or urea-aldehydes. Suitable compounds include formaldehyde, formalin, paraformaldehyde, glyoxal, and glutaraldehyde. Compounds which react to form crosslinks include hexamethylenetetramine with phenolic compounds such as phenyl acetate, phenol, hydroquinone, resorcinol, and napthalene diols.

The polymers and amount used in the viscosified fluid may provide a fluid viscosity (from about 1 cP to about 5,000 cP at the treating temperature) that is sufficient to generate fracture width and facilitate transport and prevention of undue settling of the proppant within the fracture during fracture propagation. Generally, the polymer concentration is reduced to avoid proppant pack damage and maintain sufficient viscosity for opening the fracture and transporting proppant. In embodiments, the concentration of polymer may be selected to facilitate a primary goal of higher proppant loading in the fracture.

In embodiments, the viscosified fluids of the present disclosure may also be prepared from a fluid with crosslinkable components initially having a very low viscosity that can be readily pumped or otherwise handled and that are subsequently crosslinked, such as once it is downhole, to form the viscosified fluid. For example, the viscosity of the initial fluid with crosslinkable components may be from about 1 cP to about 5,000 cP, or be from about 1 cP to about 1,000 cP, or be from about 1 cP to about 100 cP at the treating temperature, which may range from a surface temperature to a bottom-hole static (reservoir) temperature. In some embodiments, the breaking agent (which may optionally be encapsulated) comprising at least one fully-coordinated transition metal compound, such as at least one strongly complexed fully-coordinated transition metal compound, or at least one fully coordinated iron compound, such as a hexacyanoferrate salt (for example, potassium hexacyanoferrate(III) and/or potassium hexacyanoferrate(II)), may be present in the fluid with crosslinkable components initially having such a very low viscosity.

Crosslinking the unviscosified fluid with crosslinkable components generally increases its viscosity. As such, having the fluid in the unviscosified state allows for pumping of a relatively less viscous fluid having relatively low friction pressures within the well tubing, and the crosslinking may be delayed in a controllable manner such that the properties of viscosified fluid are available at the rock face instead of within the wellbore. Such a transition to a viscosified fluid state may be achieved over a period of minutes or hours based on the molecular make-up of the crosslinkable components, and results in the initial viscosity of the crosslinkable fluid increasing by at least an order of magnitude. In embodiments, the breaking agent comprising at least one fully-coordinated transition metal compound, such as at least one strongly complexed fully-coordinated transition metal compound, or at least one fully-coordinated iron compound, such as a hexacyanoferrate salt (for example, potassium hexacyanoferrate(III) and/or potassium hexacyanoferrate(II)), may be present in such crosslinked viscosified fluid. In embodiments, after the viscosity of the fluid has increased by at least an order of magnitude, such as at least two orders of magnitude, the action of the breaking agent comprising at least one fully-coordinated transition metal compound, such as at least one strongly complexed fully-coordinated transition metal compound, or at least one fully-coordinated iron compound, such as a hexacyanoferrate salt (for example, potassium hexacyanoferrate(III) and/or potassium hexacyanoferrate(II)), may decrease the viscosity of the viscosified fluid by at least an order of magnitude (for example, reducing the viscosity from about 1000 centipoise at 100 sec⁻¹ at the treating temperature to about 100 centipoise at 100 sec⁻¹ at the treating temperature) at the treating temperature, such as at least two orders of magnitude at the treating temperature, or to a viscosity below that of the initial unviscosified fluid (for example from about 1000 centipoise at 100 sec⁻¹ at the treating temperature to about 10 centipoise at 100 sec⁻¹ at the treating temperature).

The unviscosified fluids or compositions suitable in the methods of the present disclosure may comprise a crosslinkable component. As discussed above, a “crosslinkable component,” as the term is used herein, is a compound and/or substance that comprises a crosslinkable moiety capable of being crosslinked by a crosslinking agent. Suitable crosslinking agents for the methods of the present disclosure would be capable of crosslinking polymer molecules to form a three-dimensional network. Suitable organic crosslinking agents include, but are not limited to, aldehydes, dialdehydes, phenols, substituted phenols, and ethers. Suitable inorganic crosslinking agents include, but are not limited to, polyvalent metals, conventional chelated polyvalent metals, and compounds capable of yielding polyvalent metals. The concentration of the cross linking agent (including the spread crosslinker) in the crosslinkable fluid may be from about 0.001 wt % to about 10 wt %, such as about 0.005 wt % to about 2 wt %, or about 0.01 wt % to about 1 wt %.

The crosslinkable component may be natural or synthetic polymers (or derivatives thereof) that comprise a crosslinkable moiety, for example, substituted galactomannans, guar gums, high-molecular weight polysaccharides composed of mannose and galactose sugars, or guar derivatives, such as hydrophobically modified guars, guar-containing compounds, and synthetic polymers. Suitable crosslinkable components may comprise a guar gum, a locust bean gum, a tara gum, a honey locust gum, a tamarind gum, a karaya gum, an arabic gum, a ghatti gum, a tragacanth gum, a carrageenen, a succinoglycan, a xanthan, a diutan, a hydroxylethylguar hydroxypropyl guar, a carboxymethylhydroxyethyl guar, a carboxymethylhydroxypropylguar, an alkylcarboxyalkyl cellulose, an alkyl cellulose, an alkylhydroxyalkyl cellulose, a carboxyalkyl cellulose ether, a hydroxyethylcellulose, a carboxymethylhydroxyethyl cellulose, a carboxymethyl starch, a copolymer of 2-acrylamido-2methyl-propane sulfonic acid and acrylamide, a terpolymer of 2-acrylamido-2methyl-propane sulfonic acid, acrylic acid, acrylamide, or derivatives thereof. In embodiments, the crosslinkable components may present at about 0.01% to about 4.0% by weight based on the total weight of the crosslinkable fluid, such as at about 0.10% to about 2.0% by weight based on the total weight of the crosslinkable fluid.

Suitable solvents for use with the unviscosified fluid, viscosified fluid, and/or breaking agents comprising at least one fully-coordinated transition metal compound, such as at least one strongly complexed fully-coordinated transition metal compound, or at least one fully-coordinated iron compound, such as a hexacyanoferrate salt (for example, potassium hexacyanoferrate(III) and/or potassium hexacyanoferrate(II)), employed in the methods of the present disclosure may be aqueous or organic based. In embodiments, the breaking agent may be introduced into the subterranean formation in a fluid (aqueous or organic) that is separate from the unviscosified fluid or viscosified fluid. In embodiments, the breaking agent may be introduced into the subterranean formation after being mixed into either an unviscosified fluid or a viscosified fluid. Aqueous solvents may include at least one of fresh water, sea water, brine, mixtures of water and water-soluble organic compounds and mixtures thereof. Organic solvents may include any organic solvent which is able to dissolve or suspend the various components of the crosslinkable fluid.

In some embodiments, the solvent, such as an aqueous solvent, may represent up to about 99.9 weight percent of the unviscosified or viscosified fluid, such as in the range of from about 85 to about 99.9 weight percent of the viscosified fluid, or from about 98 to about 99.7 weight percent of the viscosified fluid.

While the viscosified fluids or viscosified treatment fluids of the present disclosure are described herein as comprising the above-mentioned components, it should be understood that the fluids of the present disclosure may optionally comprise other chemically different materials. In embodiments, the unviscosified and/or viscosified fluids of the present disclosure may further comprise stabilizing agents, surfactants, diverting agents, or other additives. Additionally, the unviscosified and/or viscosified fluids may comprise a mixture of various crosslinking agents, and/or other additives, such as fibers or fillers, provided that the other components chosen for the mixture are compatible with the intended application. In embodiments, the unviscosified and/or viscosified fluids of the present disclosure may further comprise one or more components selected from the group consisting of a conventional gel breaker, a buffer, a proppant, a clay stabilizer, a gel stabilizer, a surfactant and a bactericide. Furthermore, the unviscosified and/or viscosified fluids may comprise buffers, pH control agents, and various other additives added to promote the stability or the functionality of the fluid. The unviscosified and/or viscosified fluids may be based on an aqueous or non-aqueous solution. The components of the unviscosified and/or viscosified fluids may be selected such that they may or may not react with the subterranean formation that is to be sealed.

In this regard, the unviscosified and/or viscosified fluids may include components independently selected from any solids, liquids, gases, and combinations thereof, such as slurries, gas-saturated or non-gas-saturated liquids, mixtures of two or more miscible or immiscible liquids, and the like, as long as such additional components allow for the breakdown of the three dimensional structure upon substantial completion of the treatment. For example, the unviscosified and/or viscosified fluids may comprise organic chemicals, inorganic chemicals, and any combinations thereof. Organic chemicals may be monomeric, oligomeric, polymeric, crosslinked, and combinations, while polymers may be thermoplastic, thermosetting, moisture setting, elastomeric, and the like. Inorganic chemicals may be metals, alkaline and alkaline earth chemicals, minerals, and the like. Fibrous materials may also be included in the crosslinkable fluid or treatment fluid. Suitable fibrous materials may be woven or nonwoven, and may be comprised of organic fibers, inorganic fibers, mixtures thereof and combinations thereof.

Stabilizing agents can be added to slow the degradation of the crosslinked structure of the viscosified fluid after its formation downhole. Stabilizing agents may include buffering agents, such as agents capable of buffering at pH of about 8.0 or greater (such as water-soluble bicarbonate salts, carbonate salts, phosphate salts, or mixtures thereof, among others). Buffering agents may be added to the crosslinkable fluid or treatment fluid in an amount from about 0.05 wt % to about 10 wt %, and from about 0.1 wt % to about 2 wt %, based upon the total weight of the unviscosified and/or viscosified fluids. Chelating agents may also be added to the unviscosified and/or viscosified fluids.

The aqueous base fluids of the fluids of the present application may generally comprise fresh water, salt water, sea water, a brine (e.g., a saturated salt water or formation brine), or a combination thereof. Other water sources may be used, including those comprising monovalent, divalent, or trivalent cations (e.g., magnesium, calcium, zinc, or iron) and, where used, may be of any weight.

Thermal stabilizers may also be included in the viscosified or unviscosified fluids. Examples of thermal stabilizers include, for example, methanol, alkali metal thiosulfate, such as sodium thiosulfate, and ammonium thiosulfate. The concentration of thermal stabilizer in the fluid may be from about 0.1 to about 5 weight %, from about 0.2 to about 2 weight %, from about 0.2 to about 1 weight %, from about 0.5 to about 1 weight % of the thermal stabilizers based on the total weight of the fracturing fluid.

One or more clay stabilizers may also be included in the viscosified or unviscosified fluids. Suitable examples include hydrochloric acid and chloride salts, such as, tetramethylammonium chloride (TMAC) or potassium chloride. Aqueous solutions comprising clay stabilizers may comprise, for example, 0.05 to 0.5 weight % of the stabilizer, based on the combined weight of the aqueous liquid and the organic polymer (i.e., the base gel). Surfactants can be added to promote dispersion or emulsification of components of the unviscosified and/or viscosified fluids, or to provide foaming of the crosslinked component upon its formation downhole. Suitable surfactants include alkyl polyethylene oxide sulfates, alkyl alkylolamine sulfates, modified ether alcohol sulfate sodium salts, or sodium lauryl sulfate, among others. Any surfactant which aids the dispersion and/or stabilization of a gas component in the fluid to form an energized fluid can be used. Viscoelastic surfactants, such as those described in U.S. Pat. Nos. 6,703,352; 6,239,183; 6,506,710; 7,303,018 and 6,482,866, the disclosures of which are incorporated herein by reference in their entireties, are also suitable for use in fluids in some embodiments. Examples of suitable surfactants also include, but are not limited to, amphoteric surfactants or zwitterionic surfactants. Alkyl betaines, alkyl amido betaines, alkyl imidazolines, alkyl amine oxides and alkyl quaternary ammonium carboxylates are some examples of zwitterionic surfactants. An example of a useful surfactant is the amphoteric alkyl amine contained in the surfactant solution AQUAT 944® (available from Baker Petrolite of Sugar Land, Tex.). A surfactant may be added to the crosslinkable fluid in an amount in the range of about 0.01 wt % to about 10 wt %, such as about 0.1 wt % to about 2 wt %.

Charge screening surfactants may be employed. In some embodiments, the anionic surfactants such as alkyl carboxylates, alkyl ether carboxylates, alkyl sulfates, alkyl ether sulfates, alkyl sulfonates, α-olefin sulfonates, alkyl ether sulfates, alkyl phosphates and alkyl ether phosphates may be used. Anionic surfactants have a negatively charged moiety and a hydrophobic or aliphatic tail, and can be used to charge screen cationic polymers. Examples of suitable ionic surfactants also include, but are not limited to, cationic surfactants such as alkyl amines, alkyl diamines, alkyl ether amines, alkyl quaternary ammonium, dialkyl quaternary ammonium and ester quaternary ammonium compounds. Cationic surfactants have a positively charged moiety and a hydrophobic or aliphatic tail, and can be used to charge screen anionic polymers such as CMHPG.

In other embodiments, the surfactant is a blend of two or more of the surfactants described above, or a blend of any of the surfactant or surfactants described above with one or more nonionic surfactants. Examples of suitable nonionic surfactants include, but are not limited to, alkyl alcohol ethoxylates, alkyl phenol ethoxylates, alkyl acid ethoxylates, alkyl amine ethoxylates, sorbitan alkanoates and ethoxylated sorbitan alkanoates. Any effective amount of surfactant or blend of surfactants may be used in aqueous energized fluids.

Friction reducers may also be incorporated in any fluid embodiment. Any suitable friction reducer polymer, such as polyacrylamide and copolymers, partially hydrolyzed polyacrylamide, poly(2-acrylamido-2-methyl-1-propane sulfonic acid) (polyAMPS), and polyethylene oxide may be used. Commercial drag reducing chemicals such as those sold by Conoco Inc. under the trademark “CDR” as described in U.S. Pat. No. 3,692,676 or drag reducers such as those sold by Chemlink designated under the trademarks FLO1003, FLO1004, FLO1005 and FLO1008 have also been found to be effective. These polymeric species added as friction reducers or viscosity index improvers may also act as excellent fluid loss additives reducing the use of conventional fluid loss additives. Latex resins or polymer emulsions may be incorporated as fluid loss additives. Shear recovery agents may also be used in embodiments.

Diverting agents may be added to improve penetration of the unviscosified and/or viscosified fluids into lower-permeability areas when treating a zone with heterogeneous permeability. The use of diverting agents in formation treatment applications is known, such as given in Reservoir Stimulation, 3^{rd} edition, M. Economides and K. Nolte, eds., Section 19.3.

The viscosified fluid for treating a subterranean formation of the present disclosure may be a fluid that has a viscosity of above about 50 centipoise at 100 sec⁻¹, such as a viscosity of above about 100 centipoise at 100 sec⁻¹ at the treating temperature, which may range from about 60° C. (140° F.) to about 135° C. (275° F.), such as from about 79.4° C. (175° F.) to about 121° C. (250° F.), from about 93.3° C. (200° F.) to about 121° C. (250° F.), or from about 93.3° C. (200° F.) to about 107° C. (225° F.). In embodiments, the crosslinked structure formed that is acted upon by the breaking agent comprising at least one fully-coordinated transition metal compound, such as at least one strongly complexed fully-coordinated transition metal compound, or at least one fully-coordinated iron compound, such as a hexacyanoferrate salt (for example, potassium hexacyanoferrate(III) and/or potassium hexacyanoferrate(II)), may be a gel that is substantially non-rigid after substantial crosslinking. In some embodiments, a crosslinked structure that is acted upon by the breaking agent comprising at least one fully-coordinated transition metal compound, such as at least one strongly complexed fully-coordinated transition metal compound, or at least one fully-coordinated iron compound, such as a hexacyanoferrate salt (for example, potassium hexacyanoferrate(III) and/or potassium hexacyanoferrate(II)), is a non-rigid gel. Non-rigidity can be determined by any techniques known to those of ordinary skill in the art. The storage modulus G′ of substantially crosslinked fluid system of the present disclosure, as measured according to standard protocols given in U.S. Pat. No. 6,011,075, the disclosure of which is hereby incorporated by reference in its entirety, may be about 150 dynes/cm² to about 500,000 dynes/cm², such as from about 1000 dynes/cm² to about 200,000 dynes/cm², or from about 10,000 dynes/cm² to about 150,000 dynes/cm².

The methods of the present disclosure may also employ a breaker in addition to the breaking agent comprising at least one fully-coordinated transition metal compound, such as at least one strongly complexed fully-coordinated transition metal compound, or at least one fully-coordinated iron compound, such as a hexacyanoferrate salt (for example, potassium hexacyanoferrate(III) and/or potassium hexacyanoferrate(II)), described above. In this regard, conventional oxidizers, enzymes, or acids may be used. Such breakers reduce the polymer's molecular weight by the action of an acid, an oxidizer, an enzyme, or some combination of these on the polymer itself. In the case of borate-crosslinked gels, increasing the pH and therefore increasing the effective concentration of the active crosslinker, the borate anion, reversibly create the borate crosslinks. Lowering the pH can just as easily remove the borate/polymer bonds. At a high pH above 8, the borate ion exists and is available to crosslink and cause gelling. At lower pH, the borate is tied up by hydrogen and is not available for crosslinking, thus gelation by borate ion is reversible.

The methods of the present disclosure may also be employed in the absence of any additional breaker (that is, other than the above-described breaking agent comprising at least one fully-coordinated transition metal compound, such as at least one strongly complexed fully-coordinated transition metal compound, or at least one fully-coordinated iron compound, such as a hexacyanoferrate salt (for example, potassium hexacyanoferrate(III) and/or potassium hexacyanoferrate(II))). In this regard, in some embodiments, apart from the at least one fully-coordinated transition metal compound, such as at least one strongly complexed fully-coordinated transition metal compound, or at least one fully-coordinated iron compound, such as a hexacyanoferrate salt (for example, potassium hexacyanoferrate(III) and/or potassium hexacyanoferrate(II)) breaking agents, such as, for example, oxidizers, enzymes, and/or acids, are absent from the fluids and methods of the present disclosure.

Embodiments may also include proppant particles that are substantially insoluble in the fluids of the formation. Proppant particles carried by the unviscosified and/or viscosified fluids remain in the fracture created, thus propping open the fracture when the fracturing pressure is released and the well is put into production. Suitable proppant materials include, but are not limited to, sand, walnut shells, sintered bauxite, glass beads, ceramic materials, naturally occurring materials, or similar materials. Mixtures of proppants can be used as well. If sand is used, it may be from about 20 to about 100 U.S. Standard Mesh in size. With synthetic proppants, mesh sizes about 8 or greater may be used. Naturally occurring materials may be underived and/or unprocessed naturally occurring materials, as well as materials based on naturally occurring materials that have been processed and/or derived. Suitable examples of naturally occurring particulate materials for use as proppants include: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc. including such woods that have been processed by grinding, chipping, or other form of particulation, processing, etc. Further information on nuts and composition thereof may be found in ENCYCLOPEDIA OF CHEMICAL TECHNOLOGY, Edited by Raymond E. Kirk and Donald F. Othmer, Third Edition, John Wiley & Sons, vol. 16, pp. 248-273, (1981).

The concentration of proppant in the unviscosified and/or viscosified can be any concentration known in the art. For example, the concentration of proppant in the fluid may be in the range of from about 0.03 to about 3 kilograms of proppant added per liter of liquid phase. Also, any of the proppant particles can further be coated with a resin to potentially improve the strength, clustering ability, and flow back properties of the proppant.

A fiber component may be included in the unviscosified and/or viscosified to achieve a variety of properties including improving particle suspension, and particle transport capabilities, and gas phase stability. Fibers used may be hydrophilic or hydrophobic in nature. Fibers can be any fibrous material, such as natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Suitable fibers may include polyester fibers coated to be highly hydrophilic, such as, but not limited to, polyethylene terephthalate (PET) fibers available from Invista Corp. Wichita, Kans., USA, 67220. Other examples of useful fibers include, but are not limited to, polylactic acid polyester fibers, polyglycolic acid polyester fibers, polyvinyl alcohol fibers, and the like. When used in the unviscosified and/or viscosified fluids, the fiber component may be included at concentrations from about 1 to about 15 grams per liter of the liquid phase of the fluid, such as a concentration of fibers from about 2 to about 12 grams per liter of liquid, or from about 2 to about 10 grams per liter of liquid.

Embodiments may further use unviscosified and/or viscosified fluids containing other additives and chemicals that are known to be commonly used in oilfield applications by those skilled in the art. These include materials such as surfactants in addition to those mentioned hereinabove, breaker activators (breaker aids) in addition to those mentioned hereinabove, oxygen scavengers, alcohol stabilizers, scale inhibitors, corrosion inhibitors, fluid-loss additives, bactericides and biocides such as 2,2-dibromo-3-nitrilopropionamine or glutaraldehyde, and the like. Also, they may include a co-surfactant to optimize viscosity or to minimize the formation of stable emulsions that contain components of crude oil.

The foregoing may be better understood by reference to the following examples, which are presented for purposes of illustration and are not intended to limit the scope of the present disclosure.

### EXAMPLES

Viscosity of polysaccharide solutions/gels can be reduced in presence of oxygen.

### Examples 1A and B

In the following examples, 3.6 grams of a high-yielding oilfield guar was added to 1 liter of tap water and hydrated by mixing for 30 minutes in a Waring blender resulting in a viscous guar solution. A separate 10% by weight solution of magnesium chloride heptahydrate was prepared in deionized water. Another separate 2% by weight solution of Sequestrene 330, a Fe(III)/DTPA powder containing about 10% Fe(III) in a 1:1 complex provided by Becker-Underwood, was prepared in deionized water.

Each test was conducted by blending 200 milliliters (ml) of the hydrated guar solution, 0.1%(v/v) of the Fe(III)/DTPA solution, 0.1% (v/v) of a boron mineral (ulexite) suspension crosslinker, and 0.1%(v/v) of a 30%(wt) NaOH solution. The liquid components were measured and added with micropipettes. This mixture was blended using a 500 ml Waring blender, and 52 ml of the borate crosslinked fracturing fluid containing approximately 10 ppm Fe(III) was added to a rheometer cup and tested at 93° C. (200° F.) according the equipment and procedures defined in ISO 13503. This test is referred to as Example 1-A.

In the second test (Example 1-B), magnesium peroxide was added to the above composition to provide a content of 0.12% by weight magnesium peroxide, and the resulting fluid was tested under the same conditions (as discussed above). As shown in FIG. 2, a composition that included a complexed ferric compound and magnesium peroxide (Example 1-B—Comparative) did not show a break (squares), whereas the composition with only the complexed ferric compound (diamonds) showed a timely and full loss of viscosity (Example 1-A).

### Example 2

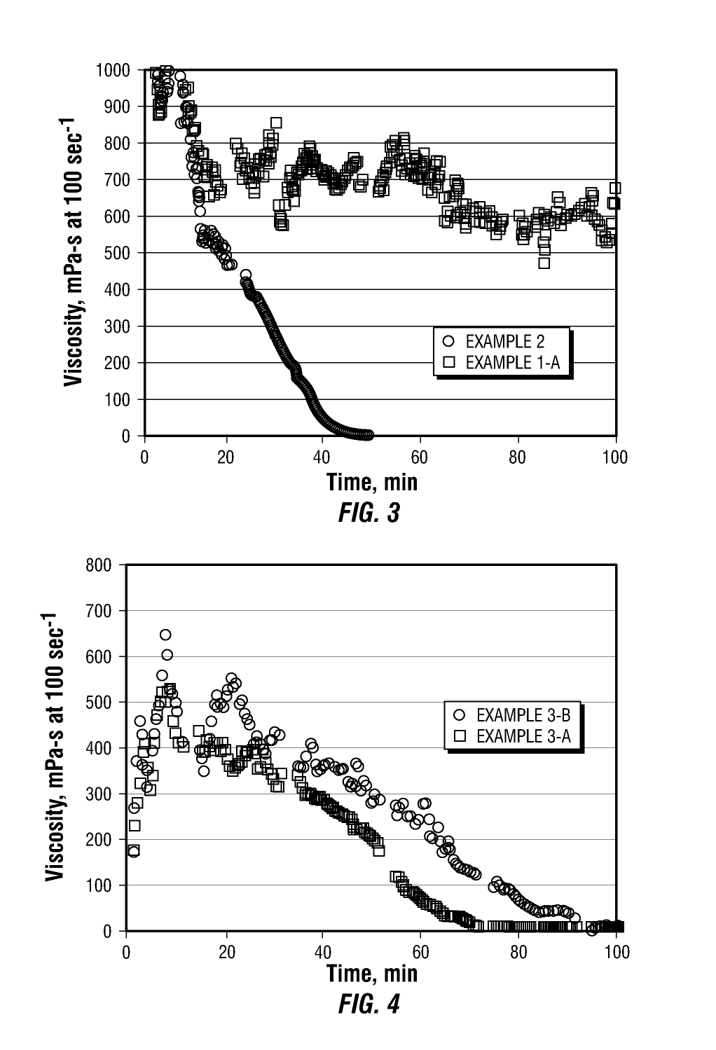

A 10% by weight aqueous solution of magnesium chloride was prepared in deionized water. Similar to Example 1, 0.078% (by volume) of the magnesium chloride solution was first added while blending, and then all of the components from Example 1-A were added in the same concentration and sequence. 52 ml of this fluid was added and then tested on the rheometer in the same manner as described above at 93° C. (200° F.) according the equipment and procedures defined in ISO 13503. As shown in FIG. 3, which includes Example 1-A (squares) for comparison, indicates that the added Mg⁺² at relatively low concentration that inhibits the breaking of the polymer.

### Example 3

A 0.36% by weight guar solution was hydrated as in Example 1. A 2% solution of potassium hexacyanoferrate(II) trihydrate was prepared by dissolving it in deionized water. To the hydrated guar solution, 0.192% (by volume) of the potassium hexacyanoferrate(II) solution, 0.2% (by volume) borax suspension crosslinker, and 0.2%(by volume) 30% NaOH solution, were added all while blending in a 500 ml Waring blender cup. The final solution contained approximately 5 ppm Fe(II). Crosslinking occurred upon mixing. 52 ml of this crosslinked solution was added to the rheometer cup and tested similarly as previous examples at 107° C. (225° F.), and is shown as squares in FIG. 4. This composition is referred to as Example 3-A. This same composition was prepared, but with 100 ppm Mg added from a 10% by weight magnesium chloride solution. It was tested the same manner, and is shown for comparison as diamonds in the plot below. This composition is referred to as Example 3-B, and is also illustrated in FIG. 4.

In this example, the more strongly complexed iron compound was able to function in water with 10 times the magnesium content as the complex tested in Example 2.

### Example 4

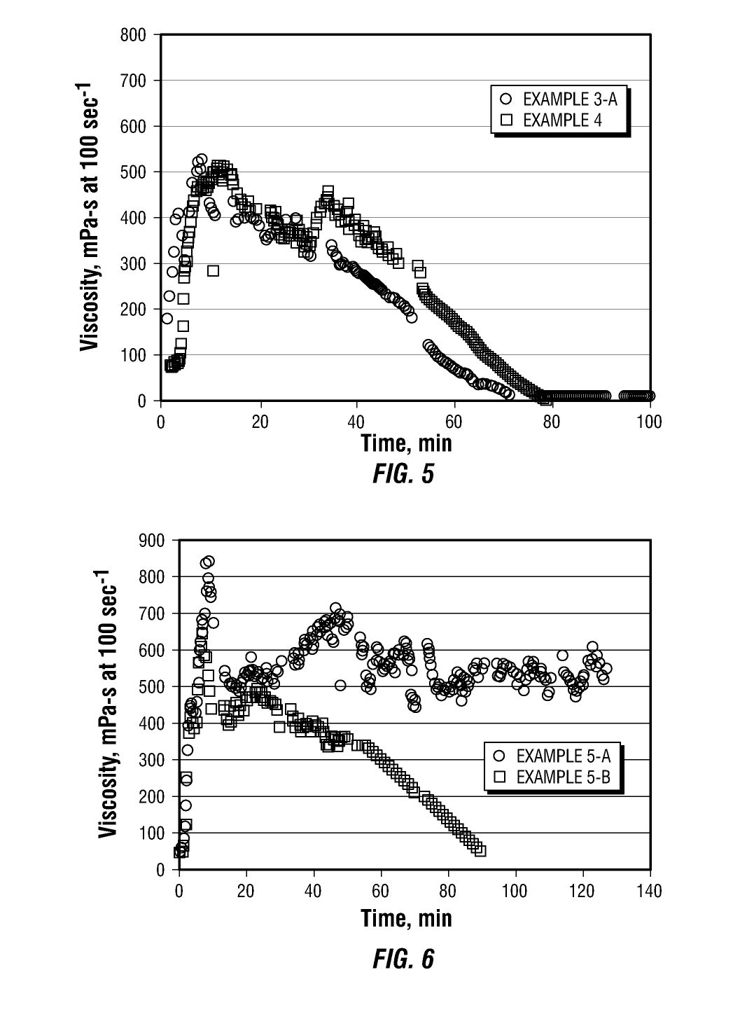

A 2% by weight solution of potassium hexacyanoferrate(III) was prepared by dissolving into deionized water. A sample was prepared for the rheometer as described in Example 1, with 5 ppm Fe(III) contributed from the aqueous hexacyanoferrate(III) solution. Like Example 3-A, the solution also contained 0.2% by volume of a borax suspension and 0.2% by volume of a 30% NaOH solution. 52 ml of the blended solution was tested similarly on the rheometer at 107° C. (225° F.). As shown in FIG. 5, comparing the sample of iron in a +3 oxidation state (Example 4—squares) to a sample of iron in a +2 oxidation state (diamonds—copied from Sample 3-A and FIG. 4), it can be clearly seen that either oxidation state performs in a similar manner.

### Example 5

A 0.36% by weight guar solution was hydrated as in Example 1. To the hydrated guar solution, 0.15% (by volume) borax suspension crosslinker, and 0.15% (by volume) 30% NaOH solution, were added all while blending in a 500 ml Waring blender cup. Crosslinking occurred upon mixing. 52 ml of this crosslinked solution was added to the rheometer cup and tested similarly as previous examples at 93° C. (200° F.), and is shown as squares on the following graph. This composition is referred to as Example 5-A. The results for this composition are shown as diamonds in FIG. 6.

A hydrated guar solution was prepared as described in the example above. A 0.5% solution of potassium hexacyanoferrate(III) was prepared by dissolving it in deionized water. To the hydrated guar solution, 0.50% (by volume) of the potassium hexacyanoferrate(III) solution, 0.02% (by weight) of calcium peroxide were added while blending in a 500 mL Waring blender cup. Similar to Example 5-A, 0.15% (by volume) borax suspension crosslinker, and 0.15% (by volume) 30% NaOH solution, were added all while blending in a 500 ml Waring blender cup. The final solution contained approximately 4.3 ppm Fe(III). Crosslinking occurred upon combining the components. This composition is referred to as Example 5-B. 52 ml of this crosslinked solution was added to the rheometer cup and tested similarly as previous examples at 93° C. (200° F.), and is shown as squares in FIG. 6.

This example demonstrates that the addition of potassium ferricyanide and calcium peroxide to the fluid effects in the loss of viscosity within 90 minutes, whereas in the absence of potassium ferricyanide and calcium peroxide the fluid maintains viscosity above 400 cP for at least 125 minutes.

### Example 6

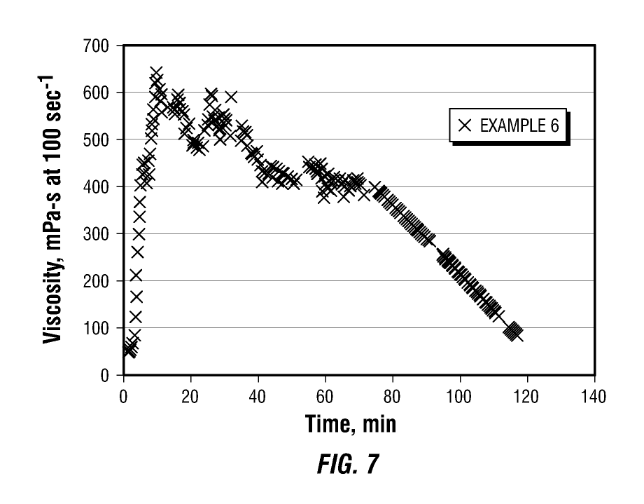

A 0.36% by weight guar solution was hydrated as in Example 1. To the hydrated guar solution, 0.006% (by weight) of Prussian Blue, 0.15% (by volume) borax suspension crosslinker, and 0.15% (by volume) 30% NaOH solution, were added all while blending in a 500 ml Waring blender cup. Crosslinking occurred upon mixing. 52 ml of this crosslinked solution was added to the rheometer cup and tested similarly as previous examples at 93° C. (200° F.), and is shown as crosses in FIG. 7.

This example demonstrates that the addition of Prussian Blue to the fluid effects the loss of viscosity within 120 minutes. In the absence of Prussian Blue, the fluid of Example 5A with the same amounts of guar, borax suspension cross-linker, and NaOH solution maintains viscosity above 400 cP for at least 125 min.

Although the preceding description has been described herein with reference to particular means, materials and embodiments, it is not intended to be limited to the particulars disclosed herein; rather, it extends to all functionally equivalent structures, methods and uses, such as are within the scope of the appended claims. Furthermore, although only a few example embodiments have been described in detail above, those skilled in the art will readily appreciate that many modifications are possible in the example embodiments without materially departing from the disclosure of METHOD OF VISCOSITY REDUCTION IN THE PRESENCE OF FULLY-COORDINATED COMPOUNDS. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112(f) for any limitations of any of the claims herein, except for those in which the claim expressly uses the words ‘means for’ together with an associated function.

What is claimed is:

1. A method for reducing a viscosity of a viscosified fluid, comprising:
introducing a viscosified fluid to a subterranean formation; and
reducing the viscosity of the viscosified fluid by reacting the viscosified fluid with a breaking agent comprising at least one fully-coordinated transition metal compound.

2. The method of claim 1, wherein the at least one fully-coordinated transition metal compound is a strongly complexed fully-coordinated transition metal compound.

3. The method of claim 1, wherein the fully-coordinated transition metal compound has a formation constant in the range of from about 28 to about 80.

4. The method of claim 1, wherein the fully-coordinated transition metal compound has a formation constant in the range of from about 45 to about 70.

5. The method of claim 1, wherein the breaking agent further comprises an oxidizer.

6. The method of claim 2, wherein the strongly complexed fully-coordinated transition metal compound is a hexacyanoferrate salt.

7. The method of claim 6, wherein the hexacyanoferrate salt is a hexacyanoferrate(II) salt.

8. The method of claim 7, wherein the hexacyanoferrate(II) salt is potassium hexacyanoferrate(II).

9. The method of claim 7, wherein the hexacyanoferrate(II) salt is iron(III) hexacyanoferrate(II) salt.

10. The method of claim 6, wherein the hexacyanoferrate salt is a hexacyanoferrate(III) salt.

11. The method of claim 10, wherein the hexacyanoferrate(III) salt is potassium hexacyanoferrate(III).

12. The method of claim 10, wherein the hexacyanoferrate(III) salt is iron(II) hexacyanoferrate(III) salt.

13. The method of claim 1, wherein reducing the viscosity of the viscosified fluid by reacting the viscosified fluid with a breaking agent comprising a hexacyanoferrate salt occurs in the absence of any other components that have a breaking effect and/or function.

14. The method of claim 13, wherein the other components that have a breaking effect and/or function are oxidizers, enzymes, and acids.

15. The method of claim 1, wherein the viscosified treatment fluid comprises a polymer selected from the group consisting of polysaccharides, galactomannans, guar, guar gums, guar derivatives, cellulose and cellulose derivatives, polyacrylamides, partially hydrolyzed polyacrylamides, copolymers of acrylamide and acrylic acid, terpolymers containing acrylamide, vinyl pyrrolidone, 2-acrylamido-2-methyl propane sulfonic acid and heteropolysaccharides.

16. The method of claim 1, wherein the viscosified fluid further comprises one or more components selected from the group consisting of a buffer, a proppant, a clay stabilizer, a gel stabilizer, a surfactant and a bactericide.

17. The method of claim 1, wherein the viscosity of the viscosified fluid is reduced by at least an order of magnitude while in the presence of Ca²⁺ and/or Mg²⁺ ions in an amount of from about 5 ppm to about 30,000 ppm.

18. The method of claim 1, wherein the viscosity of the viscosified fluid is reduced by at least an order of magnitude while in contact with the subterranean formation.

19. The method of claim 1, wherein the at least one fully-coordinated transition metal compound is created by combining a non-fully-coordinated transition metal compound and a complexing agent.

20. A method of treating a subterranean formation penetrated by a wellbore, the method comprising:
forming a viscosified treatment fluid;
treating the subterranean formation with the viscosified treatment fluid to fracture the subterranean formation; and
after the subterranean formation has been fractured, reducing the viscosity of the viscosified treatment fluid by at least 80% by introducing a breaking agent to the viscosified treatment fluid, the breaking agent comprising at least one fully-coordinated transition metal compound.

21. The method of claim 20, wherein the at least one fully-coordinated transition metal compound is a strongly complexed fully-coordinated transition metal compound.

22. The method of claim 20, wherein the fully-coordinated transition metal compound is a hexacyanoferrate salt.

23. The method of claim 22, wherein the hexacyanoferrate salt is a hexacyanoferrate(II) salt.

24. The method of claim 23, wherein the hexacyanoferrate(II) salt is potassium hexacyanoferrate(II).

25. The method of claim 23, wherein the hexacyanoferrate(II) salt is iron(III) hexacyanoferrate(II) salt.

26. The method of claim 22, wherein the hexacyanoferrate salt is a hexacyanoferrate(III) salt.

27. The method of claim 26, wherein the hexacyanoferrate(III) salt is potassium hexacyanoferrate(III).

28. The method of claim 23, wherein the hexacyanoferrate(III) salt is iron(II) hexacyanoferrate(III) salt.

29. The method of claim 20, wherein the viscosified treatment fluid comprises a polymer selected from the group consisting of polysaccharides, galactomannans, guar, guar gums, guar derivatives, cellulose and cellulose derivatives, polyacrylamides, partially hydrolyzed polyacrylamides, copolymers of acrylamide and acrylic acid, terpolymers containing acrylamide, vinyl pyrrolidone, 2-acrylamido-2-methyl propane sulfonic acid and heteropolysaccharides.

30. The method of claim 20, wherein the viscosified treatment fluid comprises a polymer selected from the group consisting of polysaccharides, galactomannans, guar, guar gums, guar derivatives, cellulose and cellulose derivatives, polyacrylamides, partially hydrolyzed polyacrylamides, copolymers of acrylamide and acrylic acid, terpolymers containing acrylamide, vinyl pyrrolidone, 2-acrylamido-2-methyl propane sulfonic acid and heteropolysaccharides.

31. The method of claim 20, wherein reducing the viscosity of the viscosified fluid by reacting the viscosified fluid with a breaking agent comprising a hexacyanoferrate salt occurs in the absence of any other components that have a breaking effect and/or function.

32. The method of claim 20, wherein reducing the viscosity of the viscosified fluid by reacting the viscosified fluid with a breaking agent comprising a hexacyanoferrate salt occurs in the absence of any other components that have a breaking effect and/or function.

33. The method of claim 20, wherein the other components that have a breaking function are oxidizers, enzymes, and acids.

34. The method of claim 20, wherein the viscosity of the viscosified fluid is reduced by at least an order of magnitude while in the presence of Ca²⁺ and/or Mg²⁺ ions in an amount of from about 5 ppm to about 30,000 ppm.

35. The method of claim 20, wherein the breaking agent is present in the viscosified treatment fluid in an amount from greater than 0% to about 0.5% by weight of the polymer in the viscosified treatment fluid.

36. The method of claim 20, wherein the at least one fully-coordinated transition metal compound is created by combining a non-fully-coordinated transition metal compound and a complexing agent.
